(19) United States
(12) Patent Application Publication
(10) Pub. No.: US 2026/0316865 A1
(43) Pub. Date: Oct. 15, 2026

(54) MOBILE PHONE MAGNETIC SUCTION INSTALLATION BRACKET WITH SPRING SHOCK ABSORPTION

(71) Applicant: Pengfei Meng, Taiyuan (CN)

(72) Inventors: Pengfei Meng, Taiyuan (CN); Sixin Jian, Chongqing (CN); Xingbo Long, Chongqing (CN); Na Luo, Nanchong (CN); Yehao Li, Jingdezhen (CN); Ziyi Zhao, Nanchong (CN)

(21) Appl. No.: 19/184,006

(22) Filed: Apr. 21, 2025

(30) Foreign Application Priority Data
Apr. 15, 2025 (CN) 202520707541.1

(51) Int. Cl. B62J 11/00; B62H 5/00; H04M 1/04; H04M 1/18

(52) U.S. Cl. CPC B62J 11/00; B62H 5/001; H04M 1/04; H04M 1/185

(57) ABSTRACT

A mobile phone magnetic suction installation bracket with spring shock absorption is provided, which includes an anti-theft seat, a rotating seat, two silicone rings, a magnetic suction seat, a plurality of buffering components, and a shock-absorbing spring. The anti-theft seat provides installation conditions for the rotating seat, and the bracket can be fixedly installed on a motorcycle through the anti-theft seat, a vibration received by the rotating seat can be buffered by the two silicone rings, and a user's mobile phone can be magnetically attracted by the magnetic suction seat. At the same time, an up-and-down vibration received by the rotating seat can be buffered by the shock-absorbing spring. The vibration received by the magnetic suction seat can be buffered by the plurality of buffering components, reducing the vibration received by the mobile phone and preventing damage caused by vibration.

### CROSS-REFERENCE TO RELATED APPLICATIONS

This application claims priority to Chinese Patent Application No. 202520707541.1, filed on Apr. 15, 2025, which is hereby incorporated by reference in its entirety.

### TECHNICAL FIELD

The present disclosure relates to the field of mobile phone holder technologies, and in particular, to a mobile phone magnetic suction installation bracket with spring shock absorption.

### BACKGROUND

Most of the current vehicle mount holders use replaceable fixed holders. In the current technology, the angle of the telescopic rod is fixed, which can only adjust the length of the phone holder and cannot adjust the angle that suits itself. Besides that, the phone is prone to running out of battery while cycling. However, it cannot be charged during cycling, resulting in the phone being unusable. Furthermore, when encountering bumpy roads, the phone is prone to slip and cause damage to the phone.

CN 209096888 U discloses a motorcycle mobile phone holder, which includes a holder and a mobile phone. The holder is fixed on the motorcycle, and the top of the holder is provided with a threaded sleeve. An internal thread of the threaded sleeve is connected to a threaded column, and a top of the threaded column is provided with a gooseneck tube. The top of the gooseneck tube is provided with a suction cup, and the top of the suction cup is provided with a mobile phone holder body. One side of the mobile phone holder body away from the gooseneck tube is provided with a connector, and the mobile phone holder body and the connector are connected by buckles connection of side walls. The connector is provided with locking pieces around the side away from the mobile phone holder body, and the connector is further provided with a suction cup on the side away from the mobile phone holder body. The mobile phone is fixed on the side of the connector through magnetic suction cup and clamping fixer. It can prevent the phone from falling off during motorcycle riding and can also charge the phone in a timely manner when it runs out of battery. The connector can also be used as a separate phone holder, which is very convenient and practical.

Using the above method does not have a shock absorption function, and the phone holder may vibrate with the vehicle during use, which may cause damage to the phone.

### SUMMARY

The purpose of the present disclosure is to provide a mobile phone magnetic suction installation bracket with spring shock absorption, which aims to solve problems of the existing mobile phone bracket that may cause damage to the mobile phone due to vibration along with the vehicle during use.

To achieve the above objectives, the present disclosure provides a mobile phone magnetic suction installation bracket with spring shock absorption, including: an anti-theft seat, a rotating seat, two silicone rings, a magnetic suction seat, a plurality of buffering components, and a shock-absorbing spring;
the rotating seat is provided on the anti-theft seat, the two silicone rings are provided on the rotating seat, the magnetic suction seat is provided on one side of the rotating seat away from the anti-theft seat, the plurality of buffering components are all provided on the magnetic suction seat, and the shock-absorbing spring is provided between the rotating seat and the anti-theft seat.

In some embodiments of the present disclosure, the anti-theft seat includes a connecting seat, an upper clamp plate, two fixing bolts, a lower clamp plate, anti-theft bolt, a limit gear ring, and a limit gear plate; the lower clamp plate is connected to the upper clamp plate through the two fixing bolts, and the anti-theft bolt penetrates through the connecting seat and the limit gear plate; the anti-theft bolt is also threaded to the upper clamp plate, and the limit gear ring is fixedly connected to the connecting seat and located inside the connecting seat; the limit gear plate is fixedly connected to the upper clamp plate and meshes with the limit gear ring; the connecting seat is fixedly connected to one end of the shock-absorbing spring.

In some embodiments of the present disclosure, the rotating seat includes a rotating rod, a first fixing shaft, and a second fixing shaft; the rotating rod is connected to the other end of the shock-absorbing spring; the first fixing shaft penetrates the rotating rod and is provided on the connecting seat; the second fixing shaft penetrates the rotating rod and is connected to the magnetic suction seat.

In some embodiments of the present disclosure, the magnetic suction seat includes a chassis, a magnetic suction frame, an unlocking paddle, a movable frame, two fitting blocks, two fixing heads, a plurality of reset springs, and a magnetic suction piece; the chassis is provided on the rotating rod through the second fixing shaft; the unlocking paddle is rotatably connected to the magnetic suction frame and located on one side of the magnetic suction frame; the movable frame is slidably connected to the magnetic suction frame and abuts against the unlocking paddle; the two fitting blocks are respectively fitted to the movable frame and are slidably connected to the magnetic suction frame; the two fixing heads are fixedly connected to the two fitting blocks and are located on the two fitting blocks, the plurality of reset springs are fixedly connected to the movable frame and fixedly connected to the magnetic attraction frame, and the magnetic suction piece is attached to the unlocking paddle.

In some embodiments of the present disclosure, the buffering components include a movable rod and a shock-absorbing rubber ring; the movable rod is slidably connected to the chassis and fixedly connected to the magnetic suction frame; the shock-absorbing rubber ring is fixedly connected to the movable rod and located between the chassis and the magnetic suction frame.

In some embodiments of the present disclosure, the chassis is composed of a left half and a right half, and an angle between the left half and the right half is 120°-140°.

The present disclosure relates to a mobile phone magnetic suction installation bracket with spring shock absorption. The anti-theft seat provides installation conditions for the rotating seat. The bracket can be fixedly provided on a motorcycle through the anti-theft seat. The vibration received by the rotating seat can be buffered by two silicone rings. The magnetic suction seat can absorb a user's mobile phone in a magnetic manner. At the same time, the shock-absorbing spring can buffer an up-and-down vibration received by the rotating seat. The plurality of buffering components can buffer the vibration received by the magnetic suction seat, thereby reducing the vibration received by the mobile phone, and preventing the mobile phone from being damaged due to vibration. This solves problems that the existing phone holder causes damage to the phone due to vibration along with the vehicle while cycling.

### BRIEF DESCRIPTION OF DRAWINGS

In order to provide a clearer explanation of the technical solutions in the embodiments of the present application or the prior art, a brief introduction will be given to the accompanying drawings required for the description of the embodiments or the prior art.

FIG. 1 is a schematic structural diagram of a mobile phone magnetic suction installation bracket with spring shock absorption according to the present disclosure.

FIG. 2 is a sectional view of the mobile phone magnetic suction installation bracket with spring shock absorption in a direction of a movable frame according to the present disclosure.

FIG. 3 is a sectional view of the mobile phone magnetic suction installation bracket with spring shock absorption in a direction of an anti-theft bolt according to the present disclosure.

FIG. 4 is a sectional view of the mobile phone magnetic suction installation bracket with spring shock absorption in a direction of a limit gear ring according to the present disclosure.

FIG. 5 is a schematic structural diagram of the mobile phone magnetic suction installation bracket with spring shock absorption in the other direction of the present disclosure.

Numeral reference: 1—silicone ring; 2—shock-absorbing spring; 3—connecting seat; 4—upper clamp plate; 5—fixing bolt; 6—lower clamp plate; 7—anti-theft bolt; 8—limit gear ring; 9—limit gear plate; 10—rotating rod; 11—first fixing shaft; 12—second fixing shaft; 13—chassis; 14—magnetic suction frame; 15—unlocking paddle; 16—movable frame; 17—fitting block; 18—fixing head; 19—reset spring; 20—magnetic suction piece; 21—movable rod; 22—shock-absorbing rubber ring; 41—left half; 42—right half.

### DESCRIPTION OF EMBODIMENTS

The embodiments of the present disclosure are described in detail below, and examples of the embodiments are shown in the accompanying drawings, where the same or similar reference numerals from beginning to end represent the same or similar elements or elements with the same or similar functions. The embodiments described below with reference to the accompanying drawings are exemplary and intended to explain the present disclosure, and should not be construed as limiting the present disclosure.

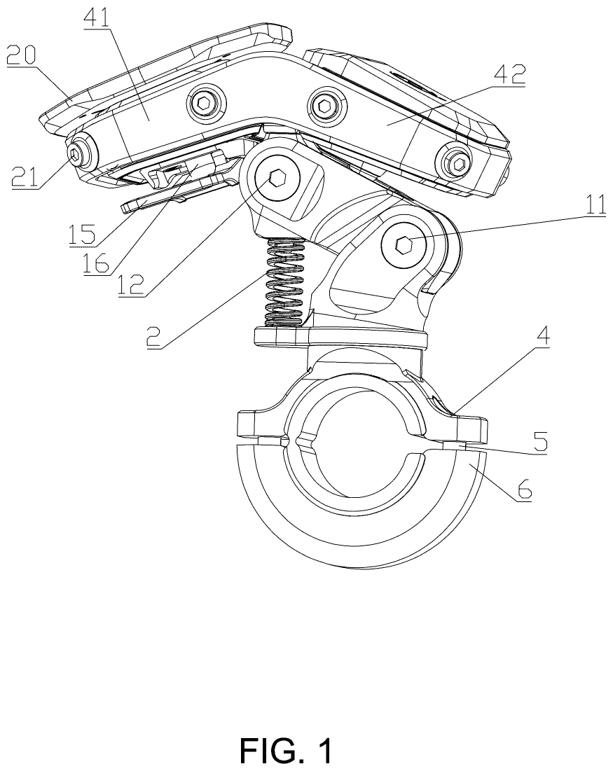

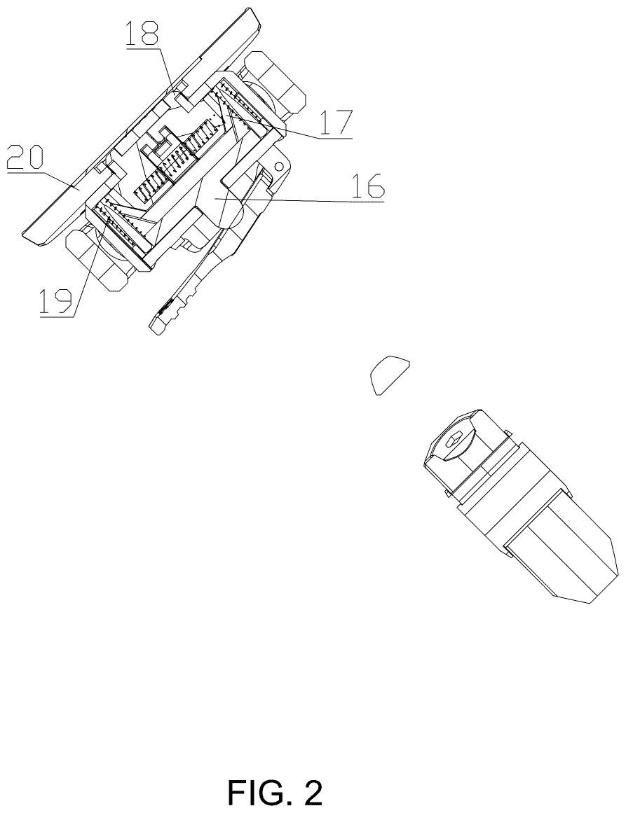

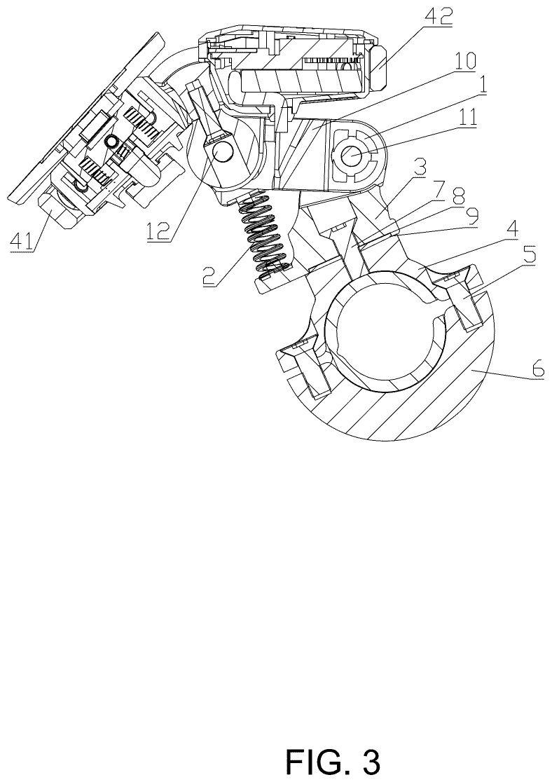

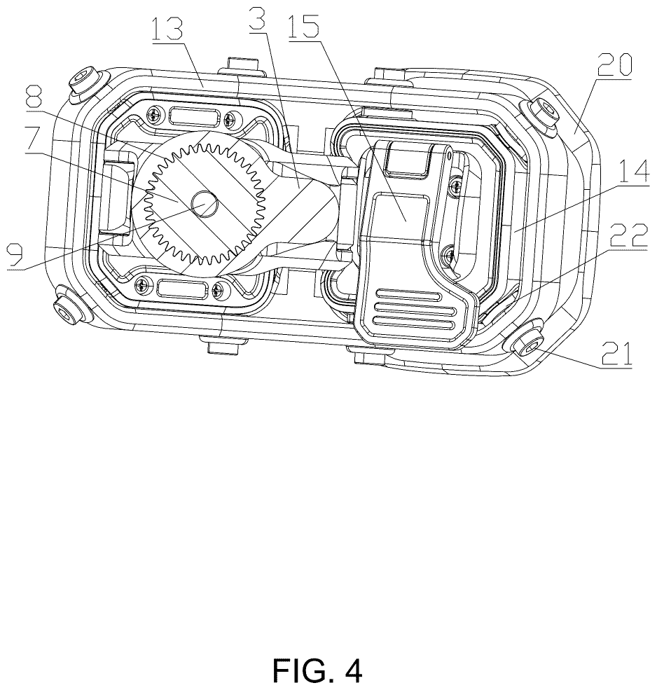

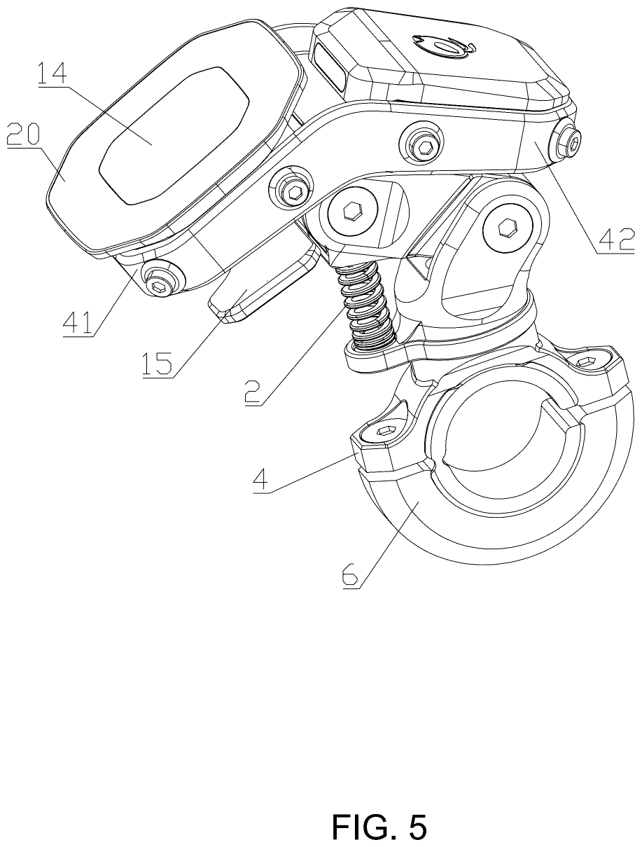

Please refer to FIGS. 1-5. The present disclosure provides a mobile phone magnetic suction installation bracket with spring shock absorption, including an anti-theft seat, a rotating seat, two silicone rings 1, a magnetic suction seat, a plurality of buffering components, and a second shock-absorbing spring 2.

The rotating seat is provided on the anti-theft seat, two first silicone rings are provided on the rotating seat, the magnetic suction seat is provided on one side of the rotating seat away from the anti-theft seat, the plurality of buffering components are all provided on the magnetic suction seat, and the shock-absorbing spring 2 is provided between the rotating seat and the anti-theft seat.

In this embodiment, the anti-theft seat provides installation conditions for the rotating seat. The bracket can be fixedly provided on a motorcycle through the anti-theft seat. The vibration received by the rotating seat can be buffered by two silicone rings 1. The magnetic suction seat can absorb a user's mobile phone in a magnetic manner. At the same time, the second shock-absorbing spring 2 can buffer an up-and-down vibration received by the rotating seat. The plurality of buffering components can buffer the vibration received by the magnetic suction seat, thereby reducing the vibration received by the mobile phone, and preventing the mobile phone from being damaged due to vibration. This solves problems that the existing phone holder causes damage to the phone due to vibration along with the vehicle while cycling.

In an implementation mode, the anti-theft seat includes a connecting seat 3, an upper clamp plate 4, two fixing bolts 5, a lower clamp plate 6, an anti-theft bolt 7, a limit gear ring 8, and a limit gear plate 9. The lower clamp plate 6 is connected to the upper clamp plate 4 through the two fixing bolts 5, and the anti-theft bolt 7 penetrates through the connecting seat 3 and the limit gear plate 9. The anti-theft bolt 7 is threaded to the upper clamp plate 4, and the limit gear ring 8 is fixedly connected to the connecting seat 3 and located inside the connecting seat 3. The limit gear plate 9 is fixedly connected to the upper clamp plate 4 and meshes with the limit gear ring 8. The connecting seat 3 is fixedly connected to one end of the shock-absorbing spring 2.

In this embodiment, the upper clamp plate 4 and the lower clamp plate 6, together with two fixing bolts 5, can be configured to install the bracket on a motorcycle body. The anti-theft bolt 7 can be configured to fix the limit gear plate 9; the limit gear plate 9, together with the limit gear ring 8, can be configured to limit the upper clamp plate 4 and prevent it from rotating. When it is necessary to remove the lower clamp plate 6, a rotating rod 10 needs to be unlocked first. When removing the bracket, a second fixing shaft 12 needs to be loosened, and a chassis 13 of the rotating rod 10 needs to be rotated. Then, a disassembly tool is inserted into an opening inside the rotating rod 10, the anti-theft bolt 7 is unscrewed, and the upper clamp plate 4 is pulled towards one side away from the connecting seat 3. The limit gear plate 9 and the limit gear ring 8 release a limit on the upper clamp plate 4, at this point, the upper clamp plate 4 can be rotated to disassemble the two fixing bolts 5.

In an implementation mode, the rotating seat includes the rotating rod 10, a first fixing shaft 11, and the second fixing shaft 12. The rotating rod 10 is connected to the other end of the shock-absorbing spring 2, the first fixing shaft 11 penetrates the rotating rod 10 and is provided on the connecting seat 3, and the second fixing shaft 12 penetrates the rotating rod 10 and is connected to the magnetic suction seat.

In an implementation mode, the rotating rod 10 provides installation conditions for the chassis 13. The rotating rod 10 can be connected to the connecting seat 3 through the first fixing shaft 11, and the rotating rod 10 can be connected to the chassis 13 through the second fixing shaft 12.

In an implementation mode, the magnetic suction seat includes the chassis 13, a magnetic suction frame 14, an unlocking paddle 15, a movable frame 16, two fitting blocks 17, two fixing heads 18, a plurality of reset springs 19, and a magnetic suction piece 20. The chassis 13 is provided on the rotating rod 10 through the second fixing shaft 12, and the unlocking paddle 15 is rotatably connected to the magnetic suction frame 14 and located on one side of the magnetic suction frame 14. The movable frame 16 is slidably connected to the magnetic suction frame 14 and abuts against the unlocking paddle 15. The two fitting blocks 17 are respectively fitted to the movable frame 16 and slidably connected to the magnetic suction frame 14. The two fixing heads 18 are fixedly connected to the two fitting blocks 17 and located on the two fitting blocks 17 respectively. The plurality of reset springs 19 are fixedly connected to the movable frame 16 and the magnetic suction frame 14 respectively. The magnetic suction piece 20 is attached to the unlocking paddle 15.

In an implementation mode, an intelligent module is provided on the chassis 13, and the intelligent module has a static sentinel mode and a riding mode.

(1) Static sentinel mode: the intelligent module is provided with a gyroscope and radio frequency signals. When in a static state, if someone rides a bike or accidentally falls, the gyroscope can sense changes in the motorcycle's angle and trigger an alarm on a mobile app.

(2) Riding mode, the intelligent module can sense a deviation of the vehicle condition, thereby generating a riding report during riding, and determining a riding position. The chassis 13 provides installation conditions for the plurality of buffering components. The magnetic suction piece 20 is attached to a back of the mobile phone, and the magnetic suction piece 20 can be used to cooperate with the magnetic suction frame 14 to attract the mobile phone. The two fixing heads 18 have inclined surfaces. When the magnetic suction piece 20 is lowered, the two fixing heads 18 are forced to approach each other. After the magnetic suction piece 20 is attracted, the two fixing heads 18 reset and fix the magnetic suction piece 20 in a limited position. When the mobile phone needs to be removed, the unlocking paddle 15 is rotated to one side close to the magnetic suction frame 14, and the unlocking paddle 15 drives the movable frame 16 to move upward. The movable frame 16 drives two fitting blocks 17 to approach each other, and the two fitting blocks 17 are subjected to force to drive two fixing heads 18 to approach each other. The two fixing heads 18 release the limit on the magnetic suction piece 20. At this point, the phone can be removed from one side away from the magnetic suction frame 14, and the movable frame 16 can be reset through the plurality of reset springs 19.

In an implementation mode, the buffering component includes a movable rod 21 and a shock-absorbing rubber ring 22. The movable rod 21 is slidably connected to the chassis 13 and fixedly connected to the magnetic suction frame 14. The shock-absorbing rubber ring 22 is fixedly connected to the movable rod 21 and located between the chassis 13 and the magnetic suction frame 14.

In an implementation mode, the movable rod 21 provides installation conditions for the shock-absorbing rubber ring 22. When the magnetic suction frame 14 is subjected to vibration, the shock-absorbing rubber ring 22 is contracted so as to provide shock-absorbing and buffering for the magnetic suction frame 14, thereby reducing the vibration received by the magnetic suction frame 14.

In an implementation mode, the chassis 13 is composed of a left half 41 and a right half 42, an angle between the left half 41 and the right half 42 is 120°-140°.

In an implementation mode, the left half 41 is configured to install the magnetic suction frame 14, and the right half 42 is configured to install the intelligent module. By providing the angle between the left half 41 and the right half 42, a signal reception and a transmission efficiency of the intelligent module can be improved, and the signal of the intelligent module can be avoided from being affected by obstruction when the mobile phone is installed on the bracket.

The above disclosure is only one or more preferred embodiments of the present application and cannot be used to limit the scope of the present application. Those skilled in the art can understand that implementing all or part of the process of the above embodiments and rendering equivalent changes according to the claims of the present application still fall within the scope of the present application.

What is claimed is:

1. A mobile phone magnetic suction installation bracket with spring shock absorption, comprising: an anti-theft seat, a rotating seat, two silicone rings, a magnetic suction seat, a plurality of buffering components, and a shock-absorbing spring;
the rotating seat is provided on the anti-theft seat, the two silicone rings are provided on the rotating seat, the magnetic suction seat is provided on one side of the rotating seat away from the anti-theft seat, the plurality of buffering components are all provided on the magnetic suction seat, and the shock-absorbing spring is provided between the rotating seat and the anti-theft seat.

2. The mobile phone magnetic suction installation bracket with spring shock absorption according to claim 1, wherein the anti-theft seat comprises a connecting seat, an upper clamp plate, two fixing bolts, a lower clamp plate, anti-theft bolt, a limit gear ring, and a limit gear plate;
the lower clamp plate is connected to the upper clamp plate through the two fixing bolts, and the anti-theft bolt penetrates through the connecting seat and the limit gear plate;
the anti-theft bolt is also threaded to the upper clamp plate, and the limit gear ring is fixedly connected to the connecting seat and located inside the connecting seat;
the limit gear plate is fixedly connected to the upper clamp plate and meshes with the limit gear ring;
the connecting seat is fixedly connected to one end of the shock-absorbing spring.

3. The mobile phone magnetic suction installation bracket with spring shock absorption according to claim 2, wherein the rotating seat comprises a rotating rod, a first fixing shaft, and a second fixing shaft;
the rotating rod is connected to the other end of the shock-absorbing spring;
the first fixing shaft penetrates the rotating rod and is provided on the connecting seat;
the second fixing shaft penetrates the rotating rod and is connected to the magnetic suction seat.

4. The mobile phone magnetic suction installation bracket with spring shock absorption according to claim 3, wherein the magnetic suction seat comprises a chassis, a magnetic suction frame, an unlocking paddle, a movable frame, two fitting blocks, two fixing heads, a plurality of reset springs, and a magnetic suction piece;
the chassis is provided on the rotating rod through the second fixing shaft;
the unlocking paddle is rotatably connected to the magnetic suction frame and located on one side of the magnetic suction frame;
the movable frame is slidably connected to the magnetic suction frame and abuts against the unlocking paddle;
the two fitting blocks are respectively fitted to the movable frame and are slidably connected to the magnetic suction frame;
the two fixing heads are fixedly connected to the two fitting blocks and are located on the two fitting blocks, the plurality of reset springs are fixedly connected to the movable frame and fixedly connected to the magnetic attraction frame, and the magnetic suction piece is attached to the unlocking paddle.

5. The mobile phone magnetic suction installation bracket with spring shock absorption according to claim 4, wherein the buffering components comprise a movable rod and a shock-absorbing rubber ring;
the movable rod is slidably connected to the chassis and fixedly connected to the magnetic suction frame;
the shock-absorbing rubber ring is fixedly connected to the movable rod and located between the chassis and the magnetic suction frame.

6. The mobile phone magnetic suction installation bracket with spring shock absorption according to claim 4, wherein the chassis is composed of a left half and a right half, and an angle between the left half and the right half is 120°-140°.
